(19) United States
(12) Patent Application Publication
(10) Pub. No.: US 2006/0230258 A1
(43) Pub. Date: Oct. 12, 2006

(54) Multi-thread processor and method for operating such a processor

(75) Inventor: Lorenzo Di Gregorio, Pescara (IT)

Correspondence Address: Maginot, Moore & Beck;Chase Tower, Suite 3250, 111 Monument Circle, Indianapolis, IN, 46204-5115, US

(73) Assignee: Infineon Technologies AG, Munchen (DE)

(21) Appl. No.: 11/364,834

(22) Filed: Feb. 28, 2006

(30) Foreign Application Priority Data
Feb. 28, 2005 (DE) 10 2005 009 083.4

(51) Int. Cl. G06F 9/44

(52) U.S. Cl. 712/228

(57) ABSTRACT

A multithread processor with synchronization of a command flow, with an associated data flow and with generation of a memory-triggered context switch signal comprises a synchronization device configured, when receiving a load cycle indicator flag with a positive logic signal level from a memory read access unit, to load and buffer in a synchronized fashion an associated context identifier and a target register identifier and to forward the context identifier and the target register identifier to a downstream pipeline stage and, when receiving a validity signal with a positive logic signal level from a memory system, to load and buffer in a synchronized fashion an associated memory value, and to forward the memory value to the pipeline stage. The processor comprises further a logic circuit generating, when the load cycle indicator flag with a positive logic signal level and the validity signal are received, a context switch signal with a negative logic signal level.

### BACKGROUND OF THE INVENTION

1. Field of the Invention

The invention relates to a multi-thread processor having a synchronization unit for synchronizing a command flow with an associated data flow, and for generating a memory-triggered context switch-over signal, and a method for operating such a processor.

2. Description of the Prior Art

Embedded processors and their architectures are measured by their power consumption, their throughput rate, their utilization rate, their costs and their real time capability. The principle of multi-threading is used in particular to increase the throughput rate and utility rate. The basic idea of multi-threading is based on the fact that a processor processes a plurality of threads. In this context, use is made in particular of the fact that during a latency time of the one thread it is possible to process program commands of the other thread. In this context, one thread designates a control path of a code or source code or program while there are data dependencies within a thread and there are weak data dependencies, or no data dependencies, between various threads (as described in section 3 in T. Beierlein, O. Hagenbruch: “Taschenbuch Mikroprozessortechnik [Handbook of Microprocessor Technology]”, second edition, Fachbuchverlag Leipzig in the Karl-Hanser-Verlag Munich-Vienna, ISBN 3-446-21686-3). A context of thread is the execution state of the program command sequence of the thread. According to this, the context of a thread is defined as a temporary processor state during the processing of the thread by this processor. The context is held by the hardware of the processor, conventionally by the program counting register or program counter, the register file or context memory and the associated status register.

For example, in Ungerer, Theo et al. (2003) “Survey of Processors with Explicit Multithreading” in ACM Computing Surveys, Volume 35, March 2003, an extensive listing of the known multi-thread processors and their architectures is described.

In order to decode the program commands and to provide the addressing and reading of the memory locations, in a conventional pipeline of a multi-thread processor the memory read access unit or load unit, which loads data or memory values from the memory location for a corresponding program command, is only provided at a late point in the pipeline. In a multi-thread architecture this inevitably leads to the implementation of command buffers which are arranged downstream of the memory read access unit. The downstream command buffers are necessary in order to permit memory-triggered switching over of the context if, for example, a read request to the memory location is not replied to, or cannot be replied to, in a predefined time. Such implementation of command buffers (replay buffers) is described, for example, in K. W. Rudd “VLIW Processors: Efficiently Exploiting Instruction Level Parallelism”, PhD Thesis, Stanford University, December 1999.

The command buffers which, according to the known implementations, are arranged downstream of the memory read access unit in the pipeline disadvantageously have to be implemented in such a large size that they can buffer all the program commands which may be respectively located in the pipeline above the command buffer for each thread to be processed by the multi-thread processor so that switching over of the thread without clock cycle loss is ensured. If, for example, a multi-thread processor processes three threads, and if the pipeline has three pipeline stages above the memory read access unit, three command buffers have to be implemented with at least four memory locations each. This means that relatively large command buffers have to be provided and they require a large amount of space and their implementation entails high costs.

### SUMMARY OF THE INVENTION

It is an object of the present invention to provide a memory-triggered context switch for a multi-thread processor while using as little command buffering as possible.

The object is achieved in accordance with the invention by means of a multi-thread processor with synchronization of a command flow with an associated data flow and with a generation of a memory-triggered context switch signal, with the multi-thread processor having:
one synchronization unit which, when a load cycle indicator flag is received with a positive logic signal level from a memory read access unit, loads and buffers in a synchronized fashion an associated context identifier and a target register identifier and passes on to a downstream pipeline stage, and when a validity signal is received with a positive logic signal level from a memory system, loads and buffers in a synchronized fashion a corresponding memory value and passes it on to a downstream pipeline stage, and which has a logic circuit which, when the load cycle indicator flag with a positive logic signal level and the validity signal are received, generates the context switch-over signal with a negative logic signal level.

The object is also achieved in accordance with the invention by means of a method for processing the multi-thread processor with synchronization of a command flow with an associated data flow and with generation of a memory-triggered context switch signal, the inventive method having the following method steps:
reception of a load cycle indicator flag from a memory read access unit;
loading of a context identifier which is associated with the load cycle indicator flag, and of an associated target register identifier by the memory read access unit if the received load cycle indicator flag has a positive logic signal level;
reception of a validity signal from a memory system;
loading of a memory value which is associated with the received validity signal by the memory system if the received validity signal has a positive logic signal level;
synchronized buffering of the loaded context identifier and of the loaded target register identifier with the associated loaded memory value, and passing on of the synchronized data; and
generation of a context switch-over signal if the received load cycle indicator flag has a positive logic signal level, and the received validity signal has a negative logic signal level.

The inventive generation of the context switch signal advantageously provides a cost-effective and very simple possible way of implementing a memory-triggered context switching-over process.

A further advantage of the present invention is that the acceptance of a potential latency time owing to the waiting for the memory values which are requested by a load command and the associated generation of the context switch-over signal according to the invention permits the command buffers to be arranged clearly above the memory read access unit in the pipeline of the multi-thread processor. In conventional implementations of multi-thread processors, a conflict-free zone of a plurality of pipeline stages, which is conditioned on the basis of other periphery conditions such as, for example, the handling of interrupts or the simplification of the driving of the processor, is embodied above the memory read access unit or load unit. This means that the conflict-free zone of pipeline stages which is inherently present above the memory read access unit owing to the other aforesaid periphery conditions is used according to the invention to arrange the command buffers above this conflict-free zone and to control by means of the context switch-over signal which is generated according to the invention. As a result, compared to the known implementation only very small replay buffers or command buffers are required according to the invention. This saves space on the circuit board of the multi-thread processor. Furthermore, the driving of the command buffers is simplified, thus saving further costs.

A further particular advantage of the inventive multi-thread processor and of the inventive method is that the data flow, the memory values and the command flow, context identifier and target register identifier are synchronized by means of the synchronization unit according to the invention.

In a restricted version of the inventive processor, the processor comprises
a memory system which has a plurality of memory locations, wherein one memory location can be addressed by a memory address and stores a variable memory value, and which makes available the corresponding memory value in response to a request transmitted to the memory system and memory address, and transmits the associated validity signal with a positive logic signal level to the synchronization unit;
a processor pipeline for processing program commands of various threads, the processor pipeline having at least:
   a memory read access unit which in the case of a load command transmits the load cycle indicator flag with a positive logic signal level to the synchronization unit in order to indicate a load cycle at the memory system, and makes available the context identifier in order to indicate the corresponding context of the load command and the target register identifier in order to indicate the target memory location of the memory system of the load command; and
   the synchronization unit.

The synchronization unit may have a first FIFO memory in which in each case the context identifier and the associated target register identifier are buffered together. The common buffering of the context identifier and of the target register identifier in a common FIFO memory advantageously ensures that this data is present arranged in a series for synchronization with the memory values.

The synchronization unit may have a second FIFO memory in which in each case the memory value is buffered. The provision of the second FIFO memory advantageously ensures that the loaded memory values are also made available in a way which is ordered for synchronization. A particular advantage of the arrangement according to the invention is that the provision of the first FIFO memory and of the second FIFO memory ensures that the context identifier and the associated target register identifier are present synchronized with the associated memory value within the synchronization unit.

The first FIFO memory and the second FIFO memory may each be embodied as a signal-edge-controlled flip-flop. The first FIFO memory and the second FIFO memory may each set an empty indicator flag at the output end to a positive logic signal level if the corresponding FIFO memory is empty.

The synchronization unit may have a first multiplexer and a second multiplexer which can be controlled by means of the logic circuit, and short-circuit the FIFO memories if the two empty indicator flags, the load cycle indicator flag which is present and the validity signal which is present are each set to a positive logic signal level. This version of the inventive processor thus ensures that when valid data can be loaded by the memory system and the two FIFO memories are empty during a load cycle, the context identifier, the target register identifier and the associated memory value can be passed on immediately in synchronism and without delay to a downstream pipeline stage.

In a restricted version of the inventive processor, the logic circuit controls the first multiplexer and the second multiplexer by means of a single control signal. The invention thus ensures that the data and command flows are synchronized.

According to a further preferred embodiment, the synchronization unit passes on without delay to the downstream pipeline stage a program command which does not require a memory value of a memory location and whose associated target register identifier is buffered in the first FIFO memory. This thus advantageously ensures that the program commands which do not require any synchronization with requested memory values are not retained by the synchronization unit.

The synchronization unit may pass on without delay a program command which writes into a memory location and whose associated target register identifier is buffered in the first FIFO memory, and may ignore the following associated memory value which has been transmitted by the corresponding memory location. This thus advantageously ensures that program commands which write into a memory location whose target register identifier is stored in the first FIFO memory are passed on immediately, and the associated memory values which are received later no longer have to be processed since the aforesaid write command writes itself into the corresponding memory location.

The pipeline stage which is arranged downstream of the synchronization unit may be embodied as a write-back unit which writes memory values which are made available as output memory values e by the synchronization unit into the corresponding memory location at an output memory address which is formed by means of the associated target register identifier.

The inventive multi-thread processor may have, for each thread to be processed, a context buffer, into each of which program commands of a specific thread can be buffered and which may be arranged at least one pipeline stage before the memory read access unit and which can each be controlled by means of the context switch-over signal.

The processor pipeline of the inventive multi-thread processor may be embodied at least by a command decoder unit for decoding a program command, a command execution unit for executing the decoded program command, the memory read access unit, the synchronization unit and the write-back unit.

In a restricted version of the inventive processor, if a program command is not a data access command or load command, the multi-thread processor processes it in a predetermined number of clock cycles.

The processor pipeline of the inventive multi-thread processor may be composed of part of a DSP processor, part of a protocol processor or part of a universal processor.

The command execution unit may be an arithmetic-logic unit or an address generator unit.

### DESCRIPTION OF THE DRAWINGS

FIG. 1 is a schematic block circuit diagram of a first preferred exemplary embodiment of an inventive multi-thread processor.

FIG. 2 is a schematic block diagram of a second preferred exemplary embodiment of an inventive multi-thread processor.

FIG. 3 is a schematic block diagram of a particularly preferred exemplary embodiment of a synchronization unit of the inventive multi-thread processor.

FIG. 4 is a schematic flowchart of a preferred exemplary embodiment of the inventive method for operating a multi-thread processor.

### DESCRIPTION OF THE PREFERRED EMBODIMENTS

Identical or functionally identical elements and signals have been provided with the same reference symbols in the figures, unless stated otherwise.

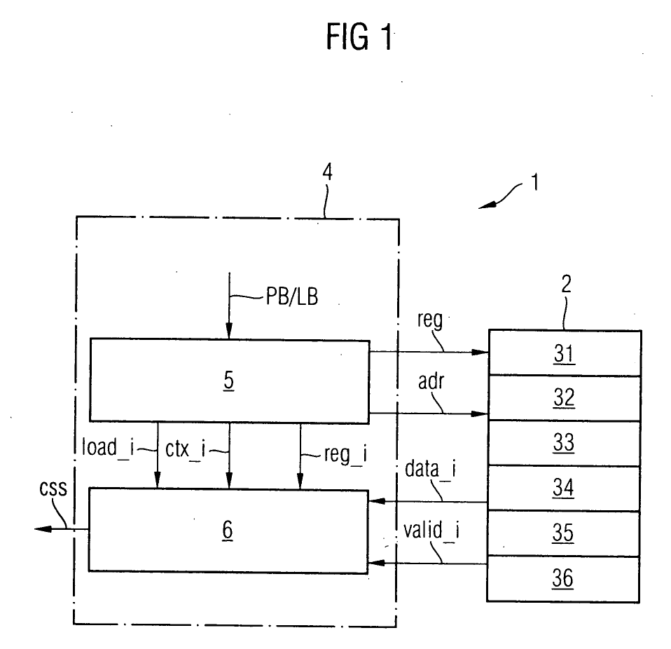

FIG. 1 shows a schematic block circuit diagram of a first preferred exemplary embodiment of the multi-thread processor 1 according to the invention. The multi-thread processor 1 according to the invention has a memory system 2 which is composed of a plurality of memory locations 31-36. A memory location 31-36 can be addressed by means of a memory address adr, and stores memory values data_i. The memory system 2 provides the corresponding memory value data_i of the corresponding memory location 31-36 in response to a request req transmitted to the memory system 2, and the memory address adr. The memory system 2 also provides an associated validity signal valid_i for specifying the validity of the supplied memory value data_i to the synchronization unit 6 or transmits it to the synchronization unit 6. The validity signal valid_i is preferably valid if it has a positive logic signal level.

The multi-thread processor 1 has also a processor pipeline 4 for processing program commands PB, LB from various threads. A load command LB or data access command is a specific program command PB which accesses the memory system 2. In this context, the processor pipeline 4 preferably contains a memory read access unit 5. When a load command LB is present, the memory read access unit 5 sets a load cycle indicator flag load_i to a positive logic signal level and transmits the load cycle indicator flag load_i to the synchronization unit 6. The load cycle indicator flag load_i indicates that a load cycle to the memory system 2 is being performed. Furthermore, the memory read access unit 5 provides a context identifier ctx_i which indicates which context or thread the corresponding load command LB is associated with. Furthermore, the memory read access unit 5 provides a target register identifier reg_i which characterizes the target register 31-36 of the memory system 2 which the corresponding load command LB accesses. The synchronization device is preferably part of the processor pipeline 4.

The synchronization unit 6 receives the load cycle indicator flag load_i from the memory read access unit 5. If the received load cycle indicator flag load_i has a positive logic signal level, the synchronization unit 6 loads the associated context identifier ctx_i and the associated target register identifier reg_i from the memory read access unit 5.

Furthermore, the synchronization unit 6 receives the validity signal valid_i from the memory system 2. If the validity signal valid_i which has been received by the synchronization unit 6 has a positive logic signal level, the synchronization unit 6 loads the associated memory value data_i of the corresponding memory location 31-36.

The synchronization unit 6 synchronizes the loaded context identifier ctx_i and the loaded target register identifier reg_i with the loaded, associated memory value data_i and buffers them. The identifications ctx_i, reg_i which have been buffered in a synchronized fashion and the memory value are then passed on to a downstream pipeline stage (not shown).

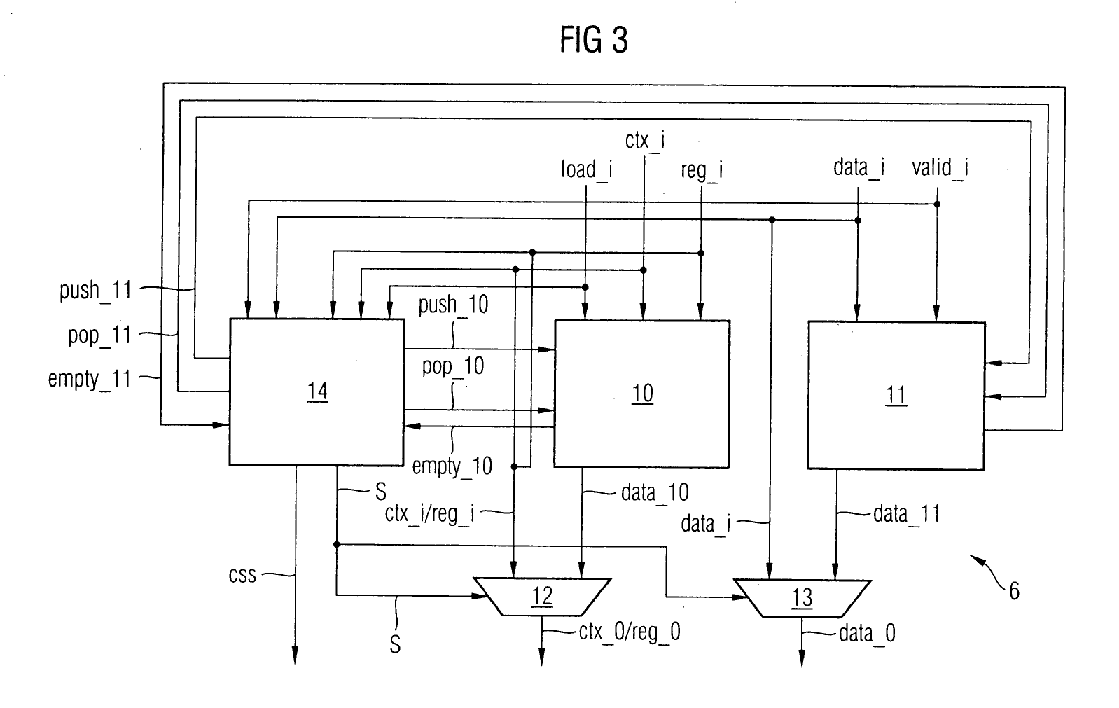

Furthermore, the synchronization unit 6 has a logic circuit 14 (cf. FIG. 3) which generates the context switch-over signal css when the load cycle indicator flag load_i is received with a positive logic signal level and the validity signal valid_i is received with a negative logic signal level.

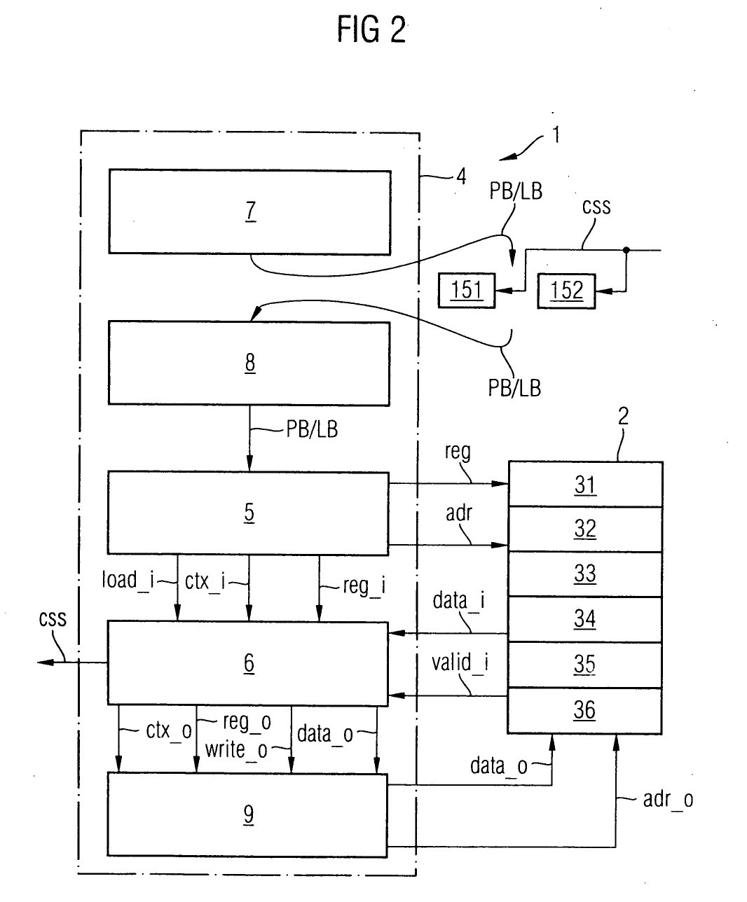

FIG. 2 shows a schematic block diagram of a second preferred exemplary embodiment of the multi-thread processor 1 according to the invention.

The multi-thread processor 1 has a memory system 2 which contains a plurality of memory locations 31-36. A memory location 31-36 can be addressed by means of a memory address adr and stores a variable memory value data_i, data_o. The memory system 2 provides the corresponding memory value data_i of the corresponding memory location 31-36 in response to a request req transmitted to the memory system 2, and memory address adr, which are both provided as a result of a load command LB from the memory read access unit 5. Furthermore, the memory system 2 also provides an associated validity signal valid_i which has a positive logic signal level for indicating the validity of the associated memory value data_i, and transmits this to the synchronization unit 6.

The multi-thread processor 1 according to the invention also has a processor pipeline 4 for processing program commands PB, LB of various threads.

The processor pipeline 4 preferably has, inter alia, a memory read access unit 5. When a load command LB is present, the memory read access unit 5 sets the load cycle indicator flag load_i to a positive logic signal level and transmits it to the synchronization unit 6. The load cycle indicator flag load_i indicates that a load cycle to the memory system 2 is being performed. The memory read access unit 5 also provides the context identifier ctx_i for indicating the corresponding context of the load command LB, and the target register identifier reg_i for indicating the target register 31-36 of the memory system 2 of the load command LB. The synchronization unit 6 is preferably part of the processor pipeline 4.

The pipeline stage 9 which is arranged downstream of the synchronization unit 6 is preferably embodied as a write-back unit which writes memory values data_i which have been provided as output memory values data_i by the synchronization unit 6 into the corresponding register 31-36 at an output memory address adr_o which is formed by means of the associated target register identifier reg_i.

The multi-thread processor 1 also preferably has for each thread to be processed a context buffer 151, 152, into each of which program commands PB, LB of a specific thread, which are arranged at least one pipeline stage before the memory read access unit 5, and which can each be controlled by means of the context switch-over signal css, are buffered. The context buffers 151, 152 are preferably arranged between a command decoder unit 7 and a command execution unit 8.

The processor pipeline 4 of the multi-thread processor 1 preferably is embodied by the command decoder unit 7 for decoding a program command PB, LB, a command execution unit 8 for executing the decoded program command PB, LB, the memory read access unit 5, the synchronization unit 6 and the write-back unit 9.

The multi-thread processor 1 preferably processes a program command PB in a predetermined number of clock cycles if it is not a data access command or load command LB.

The processor pipeline 4 of the multi-thread processor 1 is, for example, composed of part of a DSP processor, part of a protocol processor or part of a universal processor. The command execution unit 8 may be, for example, an arithmetic-logic unit (ALU) or an address generator unit (AGU).

FIG. 3 shows a schematic block diagram of a particularly preferred exemplary embodiment of the synchronization unit 6 of the multi-thread processor 1 according to the present invention. The synchronization unit 6 preferably has a first FIFO memory 10, a second FIFO memory 11, a first multiplexer 12, a second multiplexer 13 and a logic circuit 14. When a load cycle indicator flag load_i is present with a positive logic signal level, the logic circuit 14 loads the context identifier ctx_i and the associated target register identifier reg_i from the memory read access unit 5 (not shown) by means of a first push signal push_10 and buffers the loaded identifiers ctx_i, reg_i in the first FIFO memory 10.

When a validity signal valid_i is present with a positive logic signal level, the logic circuit 14 loads the corresponding memory value data_i from the corresponding memory location 31-36 of the memory system 2 (not shown) by means of a second push signal push_11 and buffers the loaded memory value data_i in the second FIFO memory 11.

The first FIFO memory 10 and the second FIFO memory 11 are each preferably embodied as a signal-edge-controlled flip-flop. The first FIFO memory 10 and the second FIFO memory 11 preferably each set an empty indicator flag empty_10, empty_11 at the output ends to a positive logic signal level and each transmit this empty indicator flag empty_10, empty_11 to the logic circuit 14 if the corresponding FIFO memory 10, 11 is empty. The logic circuit 14 pushes the first respective stored data items from the first or second FIFO memory 10, 11 by means of a first or second pop signal pop_10, pop_11.

The synchronization unit 6 preferably has a first multiplexer 12 and a second multiplexer 13. The first multiplexer 12 short-circuits, for example, the first FIFO memory 10, and the second multiplexer 13 short-circuits, for example, the second FIFO memory 11. The two FIFO memories 10, 11 are short-circuited by the two multiplexers 12, 13 if the two empty indicator flags empty_10, empty_11, the load cycle indicator flag load_i which is present and the validity signal valid_i which is present are each set to a positive logic signal level. In this context, the logic circuit 14 preferably controls the first multiplexer 12 and the second multiplexer 13 by means of a single control signal S.

The synchronization unit 6 preferably passes on, without delay, to the downstream pipeline stage 9 or write-back unit 9 a program command PB, LB which does not require a memory value data_i of a memory location 31-36 whose associated target register identifier reg_i is buffered in the first FIFO memory 10.

The synchronization unit 6 preferably passes on without delay a program command PB, LB which writes into a memory location 31-36 and whose associated target register identifier reg_i is stored in the first FIFO memory 10, and ignores the following associated memory value data_i which has been transmitted from the corresponding memory location 31-36.

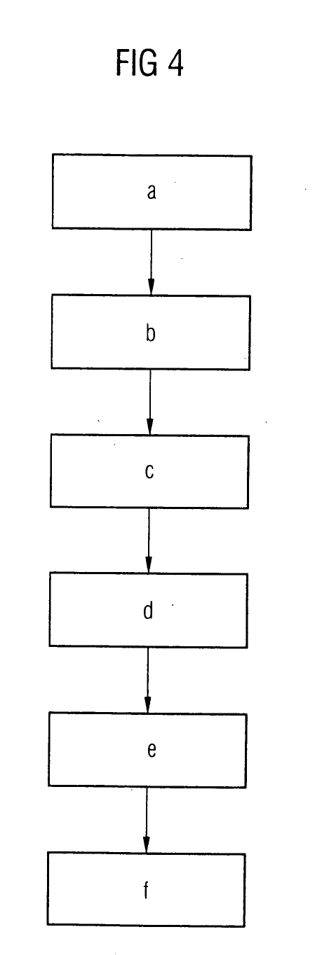

FIG. 4 shows a schematic flowchart of a preferred exemplary embodiment of the method according to the invention for operating a multi-thread processor 1 with synchronization of a command flow with an associated data flow and with generation of a memory-triggered context switch-over signal css. In this context, the method according to the invention has the following method steps:

Method step a):

Reception of a load cycle indicator flag load_i from a memory read access unit 5.

Method step b):

Loading of a context identifier ctx_i which is associated with the load cycle indicator flag load_i, and of an associated target register identifier reg_i if the received load cycle indicator flag load_i has a positive logic signal level.

Method step c):

Reception of a validity signal valid_i from a memory system 2.

Method step d):

Loading of a memory value data_i which is associated with the received validity signal valid_i by the memory system 2 if the received validity signal valid_i has a positive logic signal level.

Method step e):

Synchronized buffering of the loaded context identifier ctx_i and of the loaded target register identifier reg_i with the associated loaded memory value data_i, and passing on of the synchronized data ctx_i, reg_i, data_i.

Method step f):

Generation of a context switch-over signal css if the received load cycle indicator flag load_i has a positive logic signal level, and the received validity signal valid_i has a negative logic signal level.

Although the present invention has been described above with reference to preferred exemplary embodiments, it is not restricted to them but rather can be modified in a variety of ways. For example, the logic of the indicator flags can easily be reversed.

I claim as my invention:

1. A multithread processor with synchronization of a command flow, with an associated data flow and with generation of a memory-triggered context switch-signal, comprising:
a synchronization device configured, when receiving a load cycle indicator flag with a positive logic signal level from a memory read access unit, to load an associated context identifier and a target register identifier, and, when receiving a validity signal with a positive logic signal level from a memory system, to load an associated memory value, and to buffer in a synchronized fashion said context identifier, said target register identifier, and said memory value and to forward said context identifier, said target register identifier, and said memory value to a downstream pipeline stage; and
a logic circuit generating a context switch signal, when said load cycle indicator flag with a positive logic signal level and said validity signal with a negative logic signal level are received.

2. The processor of claim 1, further comprising:
a memory system comprised of a plurality of memory locations; wherein one of said memory locations is addressed by a memory address and stores a variable memory value and makes available a corresponding of said memory values in response to a request and memory address transmitted to said memory system and transmits an associated of said validity signals with a positive logic signal level to said synchronization device;
a processor pipeline for processing program commands of various threads, said processor pipeline comprising:
said synchronization device; and
a memory read access unit which in the case of a load command transmits said load cycle indicator flag with a positive logic signal level to said synchronization device in order to indicate a load cycle at said memory system, and makes available said context identifier in order to indicate the corresponding context of said load command and said target register identifier in order to indicate the target memory location of said load command.

3. The processor of claim 1, wherein said synchronization device comprises a first FIFO memory for buffering together said context identifier and said associated target register identifier.

4. The processor of claim 3, wherein said first FIFO memory is a signal-edge-controlled flip-flop.

5. The processor of claim 3, wherein said first FIFO memory sets a first empty indicator flag to a positive logic signal level at its output if said first FIFO memory is empty.

6. The processor of claim 1, wherein said synchronization device comprises a second FIFO memory for buffering said memory value.

7. The processor of claim 6, wherein said second FIFO memory is a signal-edge-controlled flip-flop.

8. The processor of claim 6, wherein said second FIFO memory sets a second empty indicator flag to a positive logic signal level at its output if said second FIFO memory is empty.

9. The processor of claim 5, wherein said synchronization device comprises a second FIFO memory for buffering said memory value and a first multiplexer and a second multiplexer controlled by said logic circuit; said second FIFO memory setting a second empty indicator flag to a positive logic signal level at its output if said second FIFO memory is empty and said first and second multiplexers bypassing said first and second FIFO memories if said first and second empty indicator flags, said load cycle indicator flag and said validity signal are each set to a positive logic signal level.

10. The processor of claim 9, wherein said logic circuit controls said first multiplexer and said second multiplexer by means of a single control signal.

11. The processor of claim 2, wherein said synchronization device comprises a first FIFO memory for buffering said context identifier and said associated target register identifier and said synchronization device forwards without delay to said downstream pipeline stage a program command which does not require a memory value of an associated of said memory locations and whose associated target register identifier is buffered in said first FIFO memory.

12. The processor of claim 2, wherein said synchronization device comprises a first FIFO memory for buffering said context identifier and said associated target register identifier and said synchronization device forwards without delay a program command which writes into one of said memory locations and whose associated target register identifier is buffered in said first FIFO memory, and ignores the following associated memory value which has been transmitted by the corresponding of said memory locations.

13. The processor according of claim 2, wherein said pipeline stage is embodied as a write-back unit writing said memory values made available as output memory values by said synchronization device into a corresponding of said registers at an output memory address which is formed by means of said associated target register identifier.

14. The processor of claim 1, comprising, for each thread to be processed, a context buffer for buffering program commands of a specific of said threads; said context buffers being controllable by said context switch signal and being arranged at least one pipeline stage before said memory read access unit.

15. The processor of claim 1, comprising a processor pipeline; said processor pipeline being embodied as at least one of a command decoder unit for decoding a program command, a command execution unit for executing a decoded program command, said memory read access unit, said synchronization device and a write-back unit.

16. The processor of claim 1, wherein said processor, when a program command is not a data access command or load command, processes it in a predetermined number of clock cycles.

17. The processor of claim 15, wherein said processor pipeline comprises at least one of a DSP processor, a protocol processor or a universal processor.

18. The processor of claim 15, wherein said command execution unit is an arithmetic-logic unit or an address generator unit.

19. A method for processing a multithread processor with synchronization of a command flow, with an associated data flow, and with generation of a memory-triggered context switch signal, comprising the steps of:
receiving a load cycle indicator flag from a memory read access unit;
loading a context identifier associated with said load cycle indicator flag and an associated target register identifier if said load cycle indicator flag has a positive logic signal level;
receiving a validity signal from a memory system;
loading a memory value associated with said validity signal by said memory system if said validity signal has a positive logic signal level;
synchronized buffering said context identifier being loaded and said target register identifier being loaded with said associated loaded memory value and forwarding said synchronized buffered context identifier, target register identifier and memory value; and
generating a context switch signal if said load cycle indicator flag has a positive logic signal level, and if said validity signal has a negative logic signal level.
